(19) United States
(12) Patent Application Publication
(10) Pub. No.: US 2008/0119203 A1
(43) Pub. Date: May 22, 2008

(54) METHOD AND SYSTEM FOR PROVIDING LOCATION BASED SERVICES

(76) Inventors: Yoram Shalmon, Toronto (CA); Eran Brezner, Thomhill (CA)

Correspondence Address: PERRY + CURRIER INC., 1300 YONGE STREET, SUITE 500, TORONTO, ON, M4T-1X3, omitted

(21) Appl. No.: 11/940,643

(22) Filed: Nov. 15, 2007

Related U.S. Application Data
(60) Provisional application No. 60/866,221, filed on Nov. 17, 2006.

(51) Int. Cl. H04Q 7/20

(52) U.S. Cl. 455/456.2

(57) ABSTRACT

A method and system for providing a location based service (LBS) over at least one wireless network to a mobile unit in communication with the at least one wireless network. A LBS request is received via the at least one wireless network, the LBS request comprising a request for a service available from at least one service provider. Location information associated with the mobile unit is also received. Prioritization information associated with the at least one service provider is retrieved. Data associated with the at least one service provider is accessed to determine if the at least one service provider is able to provide the service at a location proximal to the mobile unit, the location determinable from the location information. An order of priority of the at least one service provider is determined based on at least one of a determination of distance between the mobile unit and the at least one service provider, the prioritization information and the data associated with the at least one service provider. At least a portion of the data associated with the at least one service provider is provided to the mobile unit according to the order of priority.

The present application claims priority from U.S. Provisional Patent Application 60/866,221, filed Nov. 17, 2006, the contents of which are incorporated herein by reference.

### FIELD

The specification relates generally to location based services, and specifically to a method, and system architecture for services to users of mobile handsets, which relate to use of plurality of wireless networks, technologies for calculating the location of mobile devices and detecting the location of individual wireless callers.

### BACKGROUND

Wireless networks provide voice and data communication to individuals and equipment. Recently, wireless carriers introduced advanced wireless technologies into their networks, commonly known as 20, 2.5G and 30, 3G meaning “Third Generation” of wireless technological evaluation. These technologies increased communication bandwidth and allowed for improved data communication. Frequencies for wireless communication have changed from the 800-900 MHz range, (“Cellular” Range), to the 1.8-1.90 Hz (PCS Range). Other new protocols and higher frequencies have also been introduced such as WiFi (802.11) and “Bluetooth” technologies,

Location technologies were developed in response or in conjunction with regulatory requirement in the USA for “9-1-1” (locating caller to a 9-1-1 emergency number, which is outside the scope of the present specification). These technologies enable identifying the location of mobile handsets, such as Cell Phones, but vary in many respects. Various design approaches were implemented, using solutions such as Global Positioning Satellites (GPS), Cell/Sector ID, AFLT (Advanced Forward Link Trilateration), EOTD (Enhanced Observed Time Difference), A-GPS (Assisted-GPS), and E-CGI (Enhanced Cell Global Identity). Most methods involve triangulation, signal measurements and processing technologies.

Each method has different technical requirements and limitations, advantages, disadvantages, accuracy and response time. Implementation of the technology may range from a method which is fully encapsulated in the Cell Phone (i.e. GPS) to methods which are fully within the Wireless Carrier system (i.e. Cell/Sector ID), and methods which require cooperation of the Wireless Carrier, and the Cell Phone (i.e. A-GPS). However, for the purpose of the present specification, it is sufficient to assume that when a Location Service Provider (LSP) queries the Wireless Carrier, it will receive a response with the location of the Cell Phone. Such a response will include the Longitude and Latitude coordinates. It is possible that the location information will include an indicator of the accuracy of the location, additional information, such as speed and direction of movement. Note that for ease of communication, mobile communication devices which communicate over the wireless network will be referred to in this document as Cell Phones, regardless if carried by an individual, embedded in automotive or other equipment.

In recent years, the Wireless Carriers upgraded the wireless networks and Cell Phones to increase the availability and accuracy of mobile location information. This evolution enabled the introduction of Location Based Services (LBS). Based on location technologies, a number of companies have designed applications and system platforms to provide location-based services. LBS applications may be used to track a variety of moving objects (Individuals, vehicles, assets, animals etc), to record their location and to generate alerts. Typical LBS applications are:

1. A vehicle equipped with a tracking unit sends location information to a remote monitoring application, based on set reporting conditions. The vehicle may use a dedicated Cell Phone, which is loaded with company's proprietary software or a dedicated mobile location unit designed and manufactured specifically for installation in vehicles.

2. An authorized user queries the location of a Cell Phone, carried by another person.

The advantages and benefits of LBS have been recognized and LBS applications have been in use in military and civil applications for over 15 years. Yet, LBS popularity among owners of Cell Phones and the frequency of usage are limited.

The prior art describes LBS services, which may be divided into several classes, such as:

1. Services which monitor the location of mobile handset by periodic tracking of location and identify proximity to predefined areas commonly referred to as “Geo Zone” or “Geo Fences”. Hence services such as sending alerts (“Geo Alerts”) and notifications, sending coupons etc. may be provided. Such services are operating in the “push” mode, where the wireless carrier tracks mobile handset to recognize when a condition occurs. When such conditions are met, then activity will take place, such as sending sale coupons and issuing an alert.

2. Services available to a subscriber, using a mobile handset or otherwise, to obtain the location of other mobile handsets, providing authorization has been established. Such services are used for “child find” applications. Such services are also operating in the “pull” mode, where the wireless carrier tracks the location of mobile users and provide it in response to a service request by an authorized customer.

3. Services which are initiated by a service request by callers and are part of the wireless network. Such services are provided by service platforms, owned and operated by the wireless carriers, and available to service subscribers by the owner of the LBS platform, for example navigation from current location to destination. Such services have databases and protocols for interfacing with subscribers. However, by nature, such services are limited to operation within a single wireless platform owned and operated by a single wireless carrier and hence making services available only to subscribers of the specific wireless carrier.

Several key reasons, however, limit the popularity and acceptance of LBS such as difficulty of use and lack of service commonality across subscribers to multiple wireless networks. This results in difficulties in service set up and initiation, which as a result increase the complexity and cost of providing LBS.

### SUMMARY

A system and method for delivery of Location Based Service (LBS) to callers is provided. The system responds to an incoming (inbound) call which is a request for service by calculating and delivery of LBS information in an easy, individually customized and intelligent method over cell phones. Embodiments offer a method which addresses and solve difficulties in initiating and usage of LBS. This method delivers services on a voice channel, supports the introduction of services and the launch of services with minimal start up cost and complexity, while delivery of said services over multiple wireless networks and multiple Wireless Carriers.

The system responds to a service request by a subscriber, generated by a phone call to a predefined telephone number. Such telephone number has been previously advertised as an access point to the service Prior to answering the call, the embodiment sends a location query to the Wireless Carrier. The query is based on information received from the calling Cell Phone. In a non-limiting example, the received information is defined as the Caller Line Identification (CLID). Such information is available for every telephone call and may be described with a different acronym to represent the Cell Phone and in GSM/GPRS network the identity of the caller using the Cell Phone.

In the system, the location query is initiated by the system, on behalf of the caller who has previously authorized the system to get his location. The system may receive the call and further interact with the caller, possibly gathering additional information to modify the service request. The system formulates and directs the location query to the caller's Wireless Carrier based on caller's information at the subscribers, database and based, if possible, on the inbound signalling. The system can also communicate with multiple Wireless Carriers and request location information for the CLID. The caller does not receive location information, instead the caller receives information about services. The location is calculated by the Wireless Carrier and by the Cell Phone either together or separately. The system receives the CLID location information and uses it, with other information to calculate the best response.

The process of calculating the best response is implemented in an algorithm, which considers:

1. The location of the caller with consideration to the accuracy of location information.

2. Information about caller's preferences as recorded in the caller's profile in the subscribers' database. Including information such as caller's averseness to travel in order to benefit from lower prices.

3. Information about companies, hereby called Service Providers, who provide the service requested by the caller. Such information may include location, hours of operation, facilities, products, services and prices

The algorithm will create a prioritized list of Service Providers, which are unique to the caller's preferences, location and the current data. The list will be communicated to the call by voice, in subsets, so to allow the caller to listen to information and instructions. Caller may stop, start, repeat and fast forward. Caller can request that information is sent by SMS, email or other data, which is visually displayed and can be saved for further reference.

The system comprises five elements: Caller facing module (Front-End), which manages the interaction between caller and embodiments. Main Processing module (Processor), which manages and controls all system activities. Subscriber Database (S-DB), which maintains all information about callers. Content Database (C-DB), which contains data for the services offered by embodiments. Operating Support System (OSS), which maintains all administrative, provisioning and maintenance data required for operating and offering LBS to the public. Other elements may be used, such as Billing system and Web Registration however these may not be important to the core functionality of the system. In some embodiments, the databases may be separate or combined.

The method and system is unique in several aspects:

1. Use of voice interaction between subscriber and the system in the Information Request (Inbound) and Information Response (Outbound) portions of the service. The ability to use the service without touching the Cell Phone and without reading input on the Cell Phone display will greatly enhance the value and acceptability of the service. For example, it will provide for safer use by drivers and callers using mobile communication via headsets.

2. Independent from Wireless Carriers, other then sending location query and receiving location for registered users, and interfaces with multiple Wireless Carriers. Business implication is that companies, other then the Wireless Carrier, can offer service to all mobile callers. For example, callers who move from Wireless Carrier to another, using feature known as Wireless Number Portability (WNP) can maintain their LBS applications.

3. Uses intelligence to determine progression of interaction with caller.

4.Aggregates data from multiple sources, i.e. Content Providers.

5. Immediate availability of LBS, on Cell Phones, without the need to download software, preset, activate or use a dedicated tracking unit.

A first broad aspect of an embodiment seeks to provide a method for providing a Location Based Service (LBS) over at least one wireless network to a mobile unit in communication with the at least one wireless network. The method comprises receiving a LBS request via the at least one wireless network, the LBS request comprising a request for a service available from at least one service provider. The method further comprises receiving location information associated with the mobile unit. The method further comprises retrieving prioritization information associated with the at least one service provider. The method further comprises accessing data associated with the at least one service provider to determine if the at least one service provider is able to provide the service at a location proximal to the mobile unit, the location determinable from the location information. The method further comprises determining an order of priority of the at least one service provider based on at least one of a determination of distance between the mobile unit and the at least one service provider, the prioritization information and the data associated with the at least one service provider. The method further comprises providing at least a portion of the data associated with the at least one service provider to the mobile unit according to the order of priority.

The method enables any a caller to receive location based information about service providers and be connected to service provider regardless of the wireless network to which the caller is subscribed and further regardless if the caller is a registered user of the location based services.

In some embodiments of the first broad aspect, the LBS request her comprises at least one of LBS identification information, an identifier of a service type, and an identifier of the mobile unit.

In other embodiments of the first broad aspect, the location information is determined via at least one of network assisted location finding technology, electronic hardware and software embedded in the mobile unit, and interactive voice response (IVR) communication with the mobile unit.

In further embodiments of the first broad aspect, the prioritization information comprises default preferences values.

In yet further embodiments of the first broad aspect, the data associated with the at least one service provider comprises at least one of a location of the at least one service provider, price of goods and services offered by the at least one service provider, hours of operation of the at least one service provider, service availability, and advantages of the service offered by the service provider.

In some embodiments of the first broad aspect, the order of priority comprises a number representative of overall service provider priority number.

In other embodiments of the first broad aspect, the service is offered by a plurality of service providers, the plurality of service providers comprising the at least one service provider, and the providing at least a portion of the data associated with the at least one service provider to the mobile unit according to the order of priority occurs for at least one of the plurality of service providers, data associated with a service provider having the highest priority being enabled for first presentation at the mobile unit.

In further embodiments of the first broad aspect, the receiving the LBS request via the at least one wireless network is initiated from the mobile unit in response to at least one of: receiving at least a portion of a LBS provider access number at the mobile unit; receiving a short code associated with the LBS provider defined by the wireless network carrier at the mobile unit; a schedule associated with the mobile unit; and presence of the mobile unit in a given location.

In yet further embodiments of the first broad aspect, the receiving the location information associated with the mobile unit comprises at least one of: receiving at least a portion of the location information from network based location equipment remotely located from the mobile unit; receiving at least a portion of the location information from at least one location determining component associated with the mobile unit, the mobile unit comprising the at least one location determining component; and receiving at least a portion of the location information from the mobile unit by at least one of a voice interaction and a data interaction. In some of these embodiments, the network based location equipment comprises Assisted Global Position Satellites (A-GPS) equipment. In some of these embodiments, the network based location equipment comprises cell wireless network equipment, and a determination of location is made based on a Cell/Sector ID technique. In some of these embodiments, the network based location equipment comprises triangulation equipments, and a determination of location is made based on transmitted and received signal strength.

In some embodiments of the first broad aspect, the method further comprises maintaining the data associated with the at least one service provider by querying the at least one service provider for at least one of new data associated with the at least one service provider and changes to the data associated with the at least one service provider, sorting the data associated with the at least one service provider according to relevancy and storing the data associated with the at least one service provider in a database in association with a time stamp.

In other embodiments of the first broad aspect, the determining an order of priority of the at least one service provider is further based on at least one of the location, a distance between the location and a location of the at least one service provider, a threshold maximum distance between the at least one service provider and the location, hours of operation of the at least one service provider, a type of service available from the at least one service provider, price of goods and services, and a payment option made available by said at least one service provider.

In her embodiments of the first broad aspect, the providing at least a portion of the data associated with the at least one service provider to the mobile unit is performed via at least one of voice communication and text messaging.

In yet further embodiments of the first broad aspect, the method further comprises receiving a request for further data associated with the at least one service provider, responsive to the providing the data associated with the at least one service provider, via at least one of voice communication, data communication and signalling over the at least one wireless network, wherein the further data associated with the at least on service provider comprises at least one of discount coupons, saving coupons, brochures and incentive offers. In some of these embodiments, the method further comprises providing the further data associated with the at least one service provider to the mobile unit by at least one of: transmitting the further data associated with the at least one service provider to the mobile unit to request; and transferring a call from the mobile unit to the at least one service provider.

In some embodiments of the first broad aspect, the method further comprises transferring a call from the mobile unit to the at least one service provider via at least one of call transfer, call forwarding, and three-way calling, such that the mobile unit is in direct communication with the at least one service provider, the transferring occurring in response to the receiving the request for further data associated with the at least one service provider

A second broad aspect of an embodiment seeks to provide a Location Based Services (LBS) Platform for providing a location based service over a plurality of wireless networks to a plurality of mobile units coupled to the plurality of wireless networks. The LBS Platform comprises a front end for: receiving a LBS request via at least one wireless network, the LBS request comprising a request for a service available from at least one service provider; receiving location information associated with at least one mobile unit; and communicating with a plurality of service providers to retrieve data associated with the plurality of service providers. The LBS platform further comprises a processor coupled to the front end, the processor for: retrieving prioritization information associated with the at least one service provider in response to receiving the LBS request; accessing data associated with the at least one service provider to determine if the at least one service provider is able to provide the service at a location proximal to the at least one mobile unit, the location determinable from the location information; determining an order of priority of the at least one service provider based on at least one of a determination of distance between the at least one mobile unit and the at least one service provider, the prioritization information and the data associated with the at least one service provider; and providing at least a portion of the data associated with the at least one service provider to the at least one mobile unit according to the order of priority via the front end.

In some embodiments of the second broad aspect the LBS platform is operated by a business entity separate from a business entity operating the at least one wireless network, and the providing at least a portion of the data associated with the at least one service provider is independent of wireless network subscription.

In other embodiments of the second broad aspect, the front end is enabled to communicate via a plurality of frequencies, a plurality of protocols and a plurality of standards, such that the platform is enabled to service mobile units communicating via at least one of GSM/GPRS, CDMA and IDEN.

In further embodiments of the second broad aspect, the front end is enabled to accept calls from the plurality of mobile units, the calls initiated by at least one of an interaction with a mobile unit keypad, a mobile unit display voice activation, and the calls occur via at least one a voice connection and a data connection.

In yet further embodiments of the second broad aspect, the front end and the processor are enabled to respond to calls from both mobile units associated with subscribers and mobile units not associated with subscribers, the subscribers having subscribed to receiving data associated with the at least one service provider via the LBS platform.

In some embodiments of the second broad aspect, the LBS platform further comprises a database, coupled to the processor, the database enabled to: maintain data associated with the at least one service provider; and maintain user data comprising personal information, preferences, choices, usage patterns and history.

In other embodiments of the second broad aspect, the front end comprises an interactive voice response (IVR) module such that voice responses may be used to place the LBS request via the at least one mobile unit and wherein the providing at least a portion of the data associated with the at least one service provider comprises an IVR communication transmitted to the at least one mobile unit via the IVR module.

### BRIEF DESCRIPTIONS OF THE DRAWINGS

Embodiments are described with reference to the following figures, in which:

FIG. 1 depicts the system architecture, according to a non-limiting embodiment, with callers represented as Cell Phones and the wireless network, the Internet and content providers described as design blocks;

FIG. 2 depicts the location service process, according to a non-limiting embodiment, showing how requests (queries) and responses (information) are transferred between system elements, the process of bi-directional exchange of information between two elements represented as a single arrow;

FIG. 3 depicts the logic process which occurs when an Incoming (Inbound) Call initiates a location service request, according to a non-limiting embodiment, with groups of activities described in single blocks;

FIG. 4 depicts the logic process which occurs when an LBS provider, in response to a previous inbound call, generates location information Data Set, according to a non-limiting embodiment, with groups of activities described in a single block; and

FIG. 5 depicts the process for providing LBS information to a caller, according to a non-limiting embodiment.

### DETAILED DESCRIPTION OF THE EMBODIMENTS

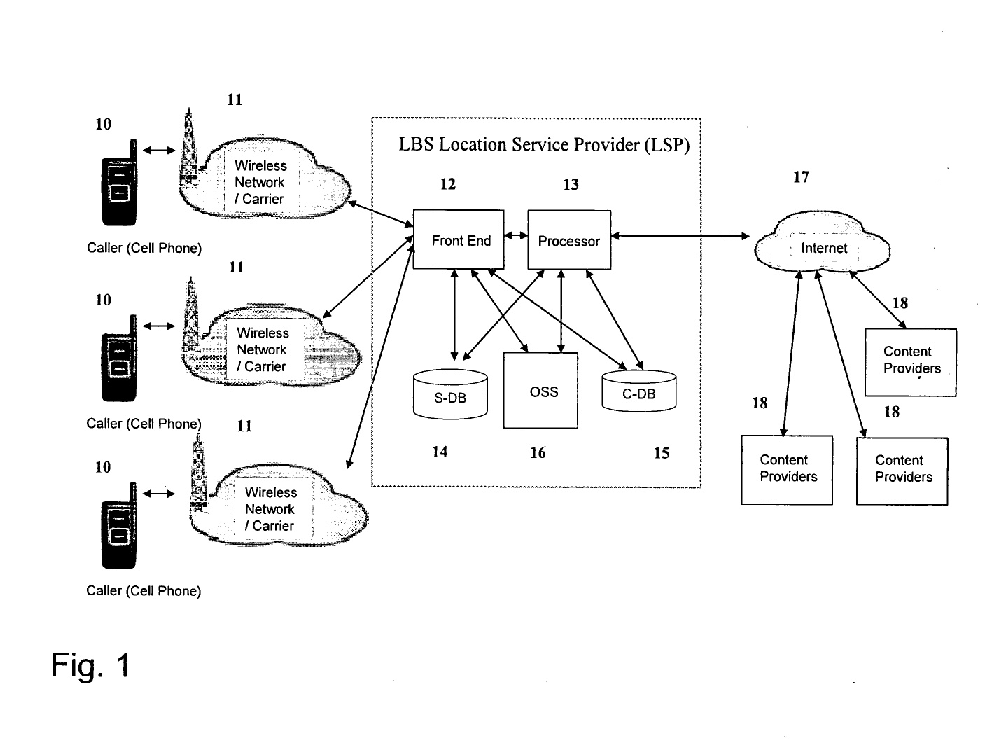

An non-limiting architecture of a system for carrier and network independent location based services is described in FIG. 1. It includes multiple Callers using Cell Phones (“Caller (Cell Phones)”) 10, multiple Wireless Carriers and multiple wireless networks operated by Wireless carriers (“Wireless Network/Carrier”) 11, the Internet as a communication medium (“Internet”) 17, multiple companies who provide location based content (“Content Providers”) 18 and the business entity which provides the complete LBS Service architecture with the system (“LBS Service Provider”). The LBS Location Service Provider (LSP) block (inside dotted line) comprises five elements:

1. A caller facing module (“Front-End”) 12 manages the interaction between caller 10 over Cell Phone and the LBS Location Service Provider. Interaction between caller and Front-End 12 can be performed with voice only, using Interactive Voice Response (IVR), Voice Recognition and Text-To-Speech technologies, leading to a simpler and safer interface, in comparison to use of Cell Phone keypad and display. The Front-End 12 can interact with multiple callers using multiple wireless carriers and multiple wireless networks 11.

2. A Main Processing module (“Processor”) 13 manages and controls activities of the other elements of the LSP. The Processor 13 is responsible for:

a. Intelligent dynamic changes in call progression based on Caller's choices and the available data.

b. Selecting, prioritizing and preparing information, based on subscriber's location.

c. Interface to Content Providers over the Internet in order to update content data.

d. Other system level activities such as system administration, Operating Support System (OSS) etc.

3. Subscribers Database (S-DB) 14 maintains information about callers. It is updated to reflect on-going changes for subscribers and for callers who are not subscribers.

4. Content Database (C-DB) 15 comprises data of various services offered by the LBS Location Service Provider. Data maybe of a permanent nature such as location of businesses (e.g. gasoline service stations), hours of operation, on site services, traffic and road conditions, etc. Data may also be of a temporary nature such as cost of goods at a business (e.g. price of gasoline in service stations), promotions and discounts, special instructions and changes in operation schedules.

5. Operating Support System (OSS) 16 maintains administrative, financial and maintenance data required for operating and offering LBS to the public.

Regardless of naming, note that the Front-End 12 has multiple processing and storage capabilities and that the Processor 13 has interfacing capabilities such as connectivity to the Internet, databases and administrative system.

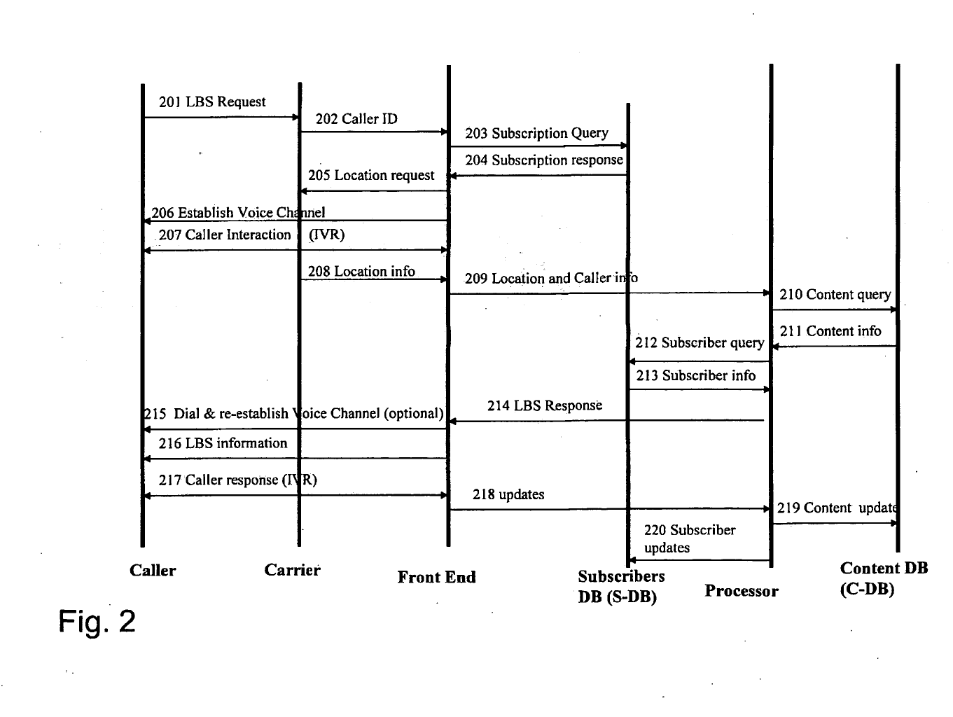

Referring to FIG. 2, an LBS request is initiated 201 by the caller (Inbound Call), who dials a pre-designated number. Such number may be for a single service, such as 1-8xx-GAS-LOC8 (for location of Gas Stations) or for multiple services such as 1-8xx-DRI-VERS (for multiple services oriented for drivers). Dialing for service may be achieved in multiple methods:

1. Voice dialing—by saying the requested number or an acronym for service, pre-programmed into the Cell Phone.

2. Keypad dialing—dialing the service access number

3. Quick dialing—dialing a preset number, pre-programmed into the Cell Phone.

4. Menu Select—selecting the number from services menu pre-programmed into the Cell Phone.

5. Others—Any other method of initiating a telephone call.

The Wireless Carrier performs a series of operations including reception of the dialed signals at a cell site and transfer of signalling information to the wireless switching center and system databases. Signalling information complies with standards but may differ between Wireless Networks. As part of the signalling process, the Wireless Carrier transfers call information, including the Caller Line Identifier (CLID) 202 to the Front End. The Front End queries 203 the Subscriber Database (S-DB) for caller status. The S-DB subscription response 204 contains information required for response to the request for service. If the Front-End determine that caller's location is required, then it will send a Location Request 205 to the Wireless Carrier. The Location Request 205 is generated for:
Every call by a subscriber will result in transfer of the CLID to the Wireless Carrier, to identify the location of the caller.
A Call by a non-subscriber may be transferred to the Wireless Carrier after an interactive process 207 to ensure and document authorization to locate the caller.

The service can be offered on any Cellular or PCS Wireless Network, regardless of the network standards (CDMA, GSM, GPRS etc).

A Voice channel is established between the caller and the Front End 206 for response to the incoming service request. The type and content of the response is determined by information maintained in the S-DB, C-DB and by system parameters, such as parameters unique to the Wireless Carrier. If there is not sufficient information about the caller to prepare a response, then the system will query the caller to obtain further location information. The queries on the established voice channel 206 and the responses 207 between the caller and the Front End may be with Interactive Voice Response (IVR) using voice recognition and keypad. The caller response 207 may range from no response (disconnect the call, no verbal or digit input) to a response by entering voice response and/or information via keypad.

Location is determined by the Cell Phone and/or by the Wireless Carrier. The determination method depends on the location technology. The process to determine the location of the Cell Phone depends on the Wireless Carrier and on the functionality of the Cell Phone. The Wireless Carrier may use a variety of methods to identify the location of the Cell Phone, however the methods are not particularly limiting to the present specification. The location may be sent as information directly from the caller's Cell Phone or from the calculating and communication resources of the Wireless Carrier. In any event the Wireless Carrier communicates location information to the Front End. In some embodiments, the location information 208 will comprise Longitude and Latitude information. In some embodiments, location information 208 may further comprise additional information such as accuracy indication, an indication of type of location method etc. If Cell Phone location cannot be calculated then the location information 208 will indicate this.

The process of acquiring the Cell Phone location may start with location request 205 before establishing voice channel 206. In some embodiments, the process of acquiring cell phone location may take approximately between 5 seconds and 60 seconds. In order to calculate the appropriate LBS information for the LBS specific request 201, the Front End will send Location and Caller information 209 to the Processor. The Processor sends Content query 210 to the Content Database (C-DB), which responds with the requested content information 211. The Processor sends a Subscriber query 212 to the S-DB and receives Subscriber information 213. The Processor runs the application software, which uses all relevant information to calculate the best possible LBS information. The LBS information is sent as LBS response 214 to the Front End. If Voice Channel has been disconnected, then the Front End will call the caller, using the CLID information and reestablish a voice channel 215. This call is considered an outbound call. The Front End sends the LBS information 216 to the caller over the voice channel. The caller may respond 217 with request for further details, data transmission and other choices, such as request for additional information. The caller response and the Front End reaction 217 is a dialog of exchanging requests and information. During and following the response to the LBS request 201, the Front End will communicate information about the call, caller and service 218 to update the Processor. The Processor will update the C-DB 219 and the S-DB 220

The LBS request 201 is an inbound call (from Caller to LBS LPS). Once a voice channel 206 is established, it may be kept for the total duration of the service. Alternatively, the inbound call may be disconnected and a new outbound call originated (from LBS LSP to Caller) once LBS information 216 is available.

The Inbound call may be terminated:

1. after the CLID information has been communicated to the Front End 202;

2. after Voice Channel established 206 and caller was greeted by the system as part of Caller interaction 207;

3. after the caller had an Interactive Voice Response (IVR) with the Front End 207; or

4. other times during the process.

If voice channel is disconnected then a new outbound call will be originated by the Front End 215 to send the LBS information 216, receive caller response 217 and following activities. Disconnecting the inbound call and originating an outbound call, once LBS information is available, will save the caller wireless airtime. For the LBS Location Service Provider (LSP) such arrangement will reduce the required communication equipment and airtime.

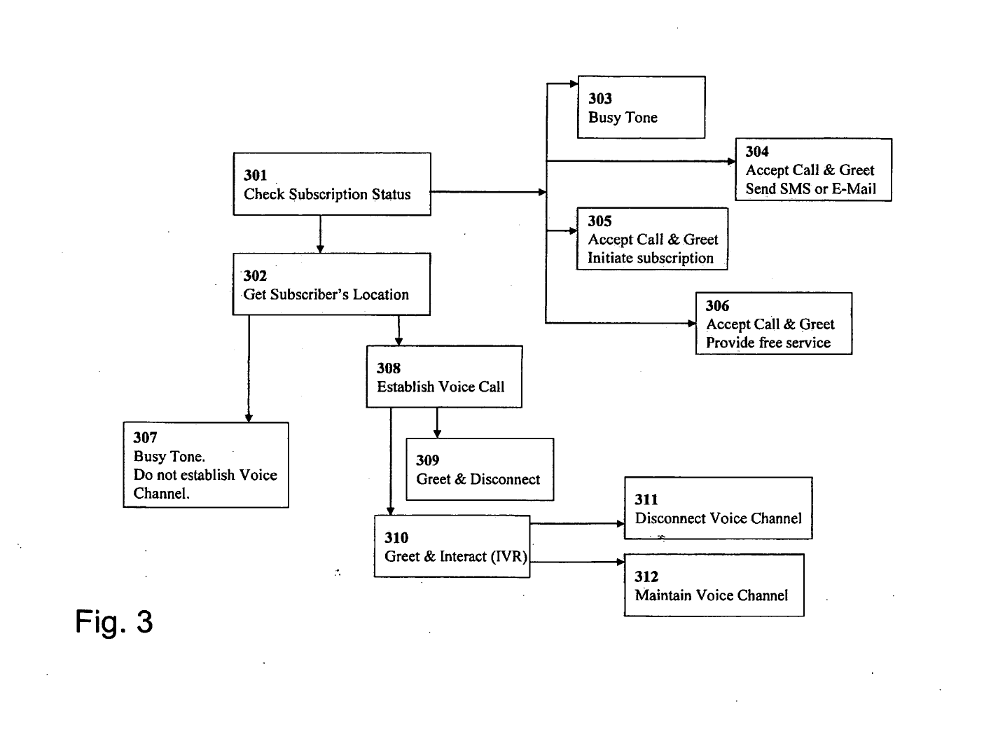

Referring now to FIG. 3, which describes how the Front End interacts with the caller, the Front End checks S-DB for subscription status 301. If the caller is a subscriber then system will proceed to query Wireless Carrier for location 302 and to provide the LBS information. If caller is not a subscriber then various options are available. Following are few alternatives:

1. Busy tone and ignore the caller 303. This action may be taken in all cases or in some cases. For example free service may be offered on a trial basis for limited time to non-subscribers. A non-subscriber who has already used the free service period may be ignored.

2. Accept the call and greet the caller 304. Provide information on subscription to the service followed (optionally) by data message (SMS and e-mail).

3. Accept the call and initiate subscription process 305. This process can be implemented with an Interactive Voice Response (IVR) using Voice and keypad or by diverting the call to customer service representative.

4. Accept the call and provide free service 306. Free service may be subject to technical and privacy limitations set by the Wireless Carrier and to business limitation set by the Location Service Provider (LSP). A process unique to each Wireless Carrier and/or the LSP may be used to authorize free service on a trail basis.

In FIG. 3, if caller is a subscriber then following action is determined by subscriber's profile, following reception of LBS information request:

1. Do not Establish Voice Channel—Avoid connection and provide a busy tone 307.

2. Establish a Voice Channel 308

a. Greet the caller 309, inform of receiving LBS request and disconnect the call.

b. Greet and interact (IVR) with the caller 310. Caller can choose from a selection of services. In a non-limiting example, if a subscriber is registered to access a set of three services: Service Stations (Gas prices), Traffic Report and Speed Traps, then the system will offer the opportunity to select a service either entering choice by voice or using cellophane's key pad.

After interaction with the caller, the system can disconnect 311 or maintain the call 312; this decision may depends on business strategy, individual subscriber preferences and dynamic call management. Decision to maintain or disconnect the Voice Channel may be impacted by, but is not limited to:

1. System choice—when the system experiences a high traffic load situation, then it may choose to disconnect the call and initiate an outbound call once information is ready.

2. Subscriber choice—the subscriber's profile indicates preference to stay on hold and listen to music, advertising or messages. As well, during the call, the subscriber can elect to stay on hold while LBS information is prepared or be called with the requested information.

3. Wireless Carrier—Each Carrier may have different response time for different location technology. If after the interactive process, the system expects the information to be available in less then a preset time value, then the call is likely to be kept.

4. Public Service content—the call may be maintained if the system has information which needs to be provided to callers, such as Traffic and Road conditions emergencies, weather alerts etc.

5. Marketing and Promotion content—the call may be maintained when the system has information of marketing and promotion values, which is to be communicated to callers.

Alternatively, the subscriber can disconnect the call voluntarily.

If the call has been disconnected, then a new call may be initiated by the system when requested information is available.

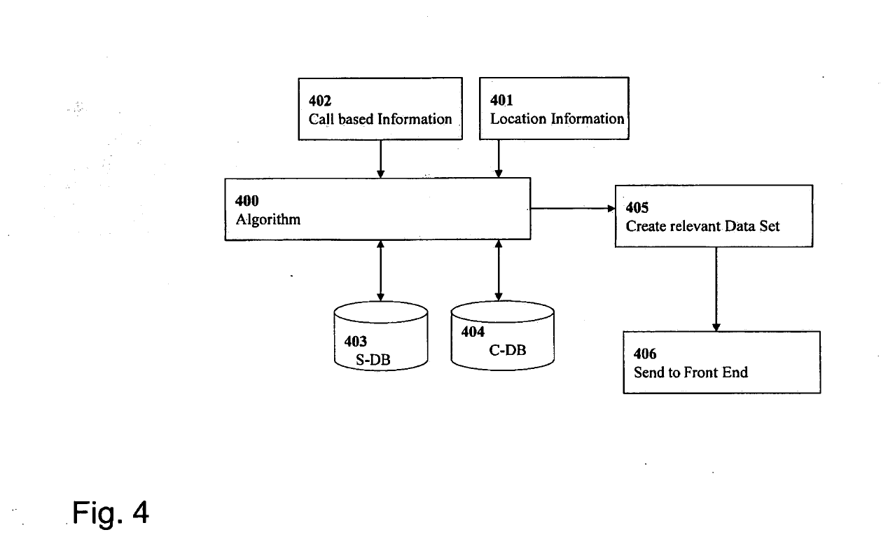

Referring to FIG. 4, an algorithm 400 in the Processor module will use the location information 401 obtained from the Wireless Carrier, information collected during the call 402, subscriber's profile information 403 from the S-DB, and the content data 404 from the C-DB, aggregated from multiple content providers. The algorithm will use the information collected to calculate a relevant data set with the requested information 405. This data set is unique to the subscriber's current request and has relevant service provider information sorted according to priority levels. The data set will be transferred 406 by the Processor module to the Front End module of the system.

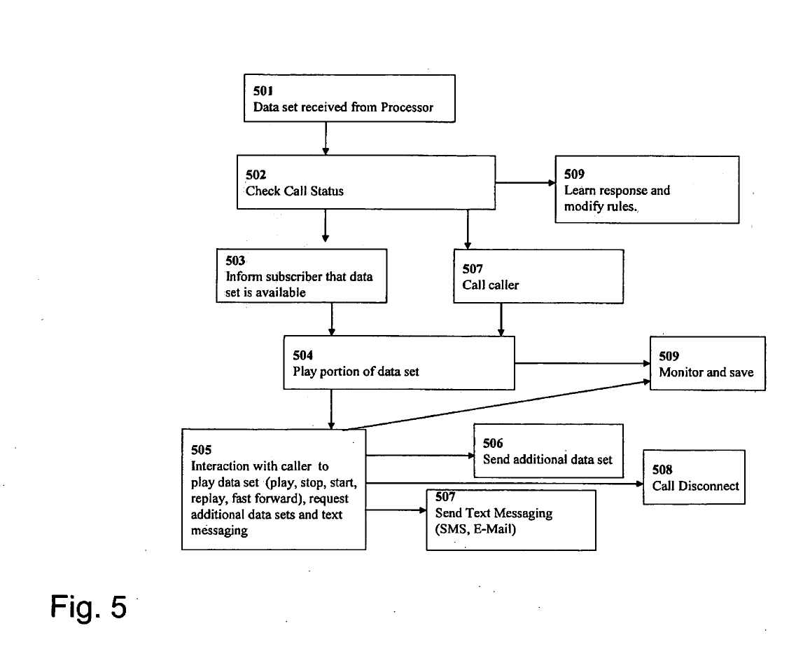

Referring to FIG. 5, which describes a process for providing the LBS information to the caller. The Processor sends Data Set with LBS information 501 to the Front End. The Front End checks the call status 502. If the initial LBS request call is still connected, then the Front End will inform 503 the caller that the required LBS data Set information is available. The Front End will play a portion of the data set 504. Voicing the data is achieved by using Text-To-Speech (TTS) and pre-recorded voice files. The caller will be able to control the played information in various methods. For example, the caller will be able to stop, start, fast forward and replay 505 the data. The caller will be able to request additional information 506 from the data set, which it can control 505 as well. It can also request to receive data via SMS or e-mail 507.

The interactive session may be ended 508 by the system or by the caller. During the interactive process, the system can monitor and save 509 behaviour patterns of the caller, which can be sent to the S-DB and make changes in the data and interaction when the caller calls again.

The Processor module interacts with different Content Providers and obtains information, which is relevant to LBS. The Processor aggregates the LBS information into the Content Database (C-DB). The information is available in the C-DB for use when an LBS query arrives. The system may also interact with Content Providers on a case-by-case basis were the system generates a request for location information to service a request by a specific caller.

Those skilled in the art will appreciate that in some embodiments, the functionality of the LBS Location Service Provider of FIG. 1 may be implemented using pre-programmed hardware or firmware elements (e.g., application specific integrated circuits (ASICs), electrically erasable programmable read-only memories (EEPROMs), etc.), or other related components. In other embodiments, the functionality of the LBS Location Service Provider of FIG. 1 may be achieved using a computing apparatus that has access to a code memory (not shown) which stores computer-readable program code for operation of the computing apparatus. The computer-readable program code could be stored on a medium which is fixed, tangible and readable directly by these components, (e.g., removable diskette, CD-ROM, ROM, fixed disk, USB drive), or the computer-readable program code could be stored remotely but transmittable to these components via a modem or other interface device connected to a network (including, without limitation, the Internet) over a transmission medium. The transmission medium may be either a non-wireless medium (e.g., optical or analog communications lines) or a wireless medium (e.g., microwave, infrared, free-space optical or other transmission schemes) or a combination thereof.

Persons skilled in the art will appreciate that there are yet more alternative implementations and modifications possible for implementing the embodiments, and that the above implementations and examples are only illustrations of one or more embodiments. The scope, therefore, is only to be limited by the claims appended hereto.

We claim:

1. A method for providing a location based service (LBS) over at least one wireless network to a mobile unit in communication with the at least one wireless network, the method comprising:
receiving a LBS request via the at least one wireless network, said LBS request comprising a request for a service available from at least one service provider;
receiving location information associated with the mobile unit;
retrieving prioritization information associated with said at least one service provider,
accessing data associated with said at least one service provider to determine if said at least one service provider is able to provide said service at a location proximal to the mobile unit, said location determinable from said location information;
determining an order of priority of said at least one service provider based on at least one of a determination of distance between said mobile unit and said at least one service provider, said prioritization information and said data associated with said at least one service provider; and
providing at least a portion of said data associated with said at least one service provider to said mobile unit according to said order of priority.

2. The method of claim 1, wherein said LBS request further comprises at least one of LBS identification information, an identifier of a service type, and an identifier of the mobile unit.

3. The method of claim 1, wherein said location information is determined via at least one of network assisted location finding technology, electronic hardware and software embedded in the mobile unit and interactive voice response (IVR) communication with the mobile unit.

4. The method of claim 1, wherein said prioritization information comprises default preferences values.

5. The method of claim 1, wherein said data associated with said at least one service provider comprises at least one of a location of said at least one service provider, price of goods and services offered by said at least one service provider, hours of operation of said at least one service provider, service availability, advantages of said service offered by said service provider, traffic conditions and road conditions.

6. The method of claim 1, wherein said order of priority comprises a number representative of overall service provider priority number.

7. The method of claim 1, wherein said service is offered by a plurality of service providers, said plurality of service providers comprising said at least one service provider, and said providing at least a portion of said data associated with said at least one service provider to said mobile unit according to said order of priority occurs for at least one of said plurality of service providers, data associated with a service provider having the highest priority being enabled for first presentation at said mobile unit.

8. The method of claim 1, wherein said receiving said LBS request via the at least one wireless network is initiated from the mobile unit in response to at least one of:
receiving at least a portion of a LBS provider access number at the mobile unit;
receiving a short code associated with said LBS provider defined by the wireless network carrier at the mobile unit;
a schedule associated with the mobile unit, and
presence of the mobile unit in a given location.

9. The method of claim 1, wherein said receiving said location information associated with the mobile unit comprises at least one of:
receiving at least a portion of said location information from network based location equipment remotely located from the mobile unit;
receiving at least a portion of said location information from at least one location determining component associated with said mobile unit, said mobile unit comprising said at least one location determining component; and
receiving at least a portion of said location information from the mobile unit by at least one of a voice interaction and a data interaction.

10. The method of claim 9, wherein said network based location equipment comprises Assisted Global Position Satellites (A-GPS) equipment.

11. The method of claim 9, wherein said network based location equipment comprises cell wireless network equipment, and a determination of location is made based on a cell/sector ID technique.

12. The method of claim 9, wherein said network based location equipment comprises triangulation equipment, and a determination of location is made based on transmitted and or received signal strength.

13. The method of claim 1, further comprising maintaining said data associated with said at least one service provider by querying said at least one service provider for at least one of new data associated with said at least one service provider and changes to said data associated with said at least one service provider, sorting said data associated with said at least one service provider according to relevancy and storing said data associated with said at least one service provider in a database in association with a time stamp.

14. The method of claim 1, wherein said determining an order of priority of said at least one service provider is further based on at least one of said location, a distance between said location and a location of said at least one service provider, a threshold maximum distance between said at least one service provider and said location, hours of operation of said at least one service provider, a type of service available from said at least one service provider, price of goods and services, and a payment option made available by said at least one service provider.

15. The method of claim 1, wherein said providing at least a portion of said data associated with said at least one service provider to the mobile unit is performed via at least one of voice communication and text messaging.

16. The method of claim 1, further comprising receiving a request for further data associated with said at least one service provider, responsive to said providing said data associated with said at least one service provider, via at least one of voice communication, data communication and signalling over the at least one wireless network, wherein said further data associated with said at least on service provider comprises at least one of discount coupons, saving coupons, brochures and incentive offers.

17. The method of claim 16, further comprising providing said further data associated with said at least one service provider to the mobile unit by at least one of:
transmitting said further data associated with said at least one service provider to the mobile unit to request; and
transferring a call from the mobile unit to said at least one service provider.

18. The method of claim 1, further comprising transferring a call from the mobile unit to said at least one service provider via at least one of call transfer, call forwarding, and three-way calling, such that the mobile unit is in direct communication with said at least one service provider, said transferring occurring in response to said receiving said request for further data associated with said at least one service provider.

19. A Location Based Services (LBS) Platform for providing a location based service over a plurality of wireless network to a plurality of mobile units coupled to the plurality of wireless networks, comprising,
a front end for:
receiving a LBS request via at least one wireless network, said LBS request comprising a request for a service available from at least one service provider;
receiving location information associated with at least one mobile unit, and
communicating with a plurality of service providers to retrieve data associated with said plurality of service providers; and
a processor coupled to said front end, said processor for:
retrieving prioritization information associated with said at least one service provider in response to receiving said LBS request;
accessing data associated with said at least one service provider to determine if said at least one service provider is able to provide said service at a location proximal to said at least one mobile unit, said location determinable from said location information;
determining an order of priority of said at least one service provider based on at least one of a determination of distance between said at least one mobile unit and said at least one service provider, said prioritization information and said data associated with said at least one service provider; and
providing at least a portion of said data associated with said at least one service provider to said at least one mobile unit according to said order of priority via said front end.

20. The LBS platform of claim 19, wherein the LBS platform is operated by a business entity separate from a business entity operating said at least one wireless network, and said providing at least a portion of said data associated with said at least one service provider is independent of wireless network subscription.

21. The LBS platform of claim 19, wherein said front end is enabled to communicate via a plurality of frequencies, a plurality of protocols and a plurality of standards, such that said platform is enabled to service mobile units communicating via at least one of GSM/GPRS, CDMA and IDEN.

22. The LBS platform of claim 19, wherein said front end is enabled to accept calls from the plurality of mobile units, said calls initiated by at least one of an interaction with a mobile unit keypad, a mobile unit display voice activation, and said calls occur via at least one a voice connection and a data connection.

23. The LBS platform of claim 19, wherein said front end and said processor are enabled to respond to calls from both mobile units associated with subscribers and mobile units not associated with subscribers, said subscribers having subscribed to receiving data associated with said at least one service provider via the LBS platform.

24. The LBS platform of claim 19, further comprising a database, coupled to said processor, said database enabled to
maintain data associated with said at least one service provider; and
maintain user data comprising personal information, preferences choices, usage patterns and history.

25. The LBS platform of claim 19, wherein said front end comprises an interactive voice response (IVR) module such that voice responses may be used to place said LBS request via said at least one mobile unit and wherein said providing at least a portion of said data associated with said at least one service provider comprises an IVR communication transmitted to said at least one mobile unit via said IVR module.
